(19) United States
(12) Patent Application Publication
(10) Pub. No.: US 2026/0243938 A1
(43) Pub. Date: Aug. 20, 2026

(54) VIRTUAL IMAGE DISPLAY APPARATUS

(71) Applicant: FUJIFILM Corporation, Tokyo (JP)

(72) Inventors: Naoyoshi YAMADA, Minamiashigara-shi (JP); Ryuji SANETO, Minamiashigara-shi (JP)

(73) Assignee: FUJIFILM Corporation, Tokyo (JP)

(21) Appl. No.: 19/640,437

(22) Filed: Apr. 7, 2026

Related U.S. Application Data
(63) Continuation of application No. PCT/JP2024/038170, filed on Oct. 25, 2024.

(30) Foreign Application Priority Data
Nov. 8, 2023 (JP) 2023-191044
Jun. 25, 2024 (JP) 2024-102118

(51) Int. Cl. G02B 5/30

(52) U.S. Cl. CPC G02B 5/3016

(57) ABSTRACT

Provided is a virtual image display apparatus in which a variation in a size of a ghost is small and occurrence of the ghost is stably reduced. Provided is a virtual image display apparatus including at least an image display device and a folded-back optical system including a reflective circular polarizer, in which the reflective circular polarizer includes a cholesteric liquid crystal layer, and in the cholesteric liquid crystal layer, a degree of alignment of a liquid crystal compound on a surface on an image display device side is 0.5 or more, and a variation in a director orientation of the liquid crystal compound in an effective region is 30° or less.

### CROSS-REFERENCE TO RELATED APPLICATIONS

This application is a Continuation of PCT International Application No. PCT/JP2024/038170 filed on Oct. 25, 2024, which claims priority under 35 U.S.C. § 119 (a) to Japanese Patent Application No. 2023-191044 filed on Nov. 8, 2023 and Japanese Patent Application No. 2024-102118 filed on Jun. 25, 2024. The above applications are hereby expressly incorporated by reference, in their entirety, into the present application.

### BACKGROUND OF THE INVENTION

### 1. Field of the Invention

The present invention relates to a virtual image display apparatus.

### 2. Description of the Related Art

In recent years, a virtual image display apparatus has been more widely used as a display apparatus that implements virtual reality display, augmented reality display, and the like. Examples of the virtual image display apparatus include a head-mounted display including an image display device and a lens. In a case where such a head-mounted display is mounted on a head of an observer and a video is displayed through a lens, it is possible to cause the user to observe the video with a realistic effect, which is called virtual reality.

In recent years, in order to reduce a thickness of such a head-mounted display, a head-mounted display including a thin lens called a pancake lens that reflects and reciprocates light between a reflective polarizer and a half mirror has been introduced. The pancake lens is also called a folded-back optical system or a reflective optical system because of a mechanism thereof. For example, JP1995-120679A (JP-H7-120679) discloses a virtual image display apparatus including a folded-back optical system in order to reduce a size and a thickness of a display unit.

### SUMMARY OF THE INVENTION

In a virtual image display apparatus including a pancake lens, a part of light (image) emitted from an image display device transmits through a half mirror, is incident into and reflected on a reflective polarizer to be folded back, is incident into the half mirror again, and is partially reflected to be folded back toward the reflective polarizer.

In a case where the light is reflected by the half mirror, the light is converted into light that is transmitted through the reflective polarizer, and the light that has been transmitted through the reflective polarizer is observed by the user.

In a pancake lens disclosed in JP1995-120679A (JP-H7-120679), some of rays emitted from an image display device are not reciprocated between a reflective polarizer and a half mirror because of disorder of polarization, undesirable reflection, and the like, and is transmitted through the reflective polarizer without being reflected in a case where the rays are incident into the reflective polarizer for the first time. The transmitted light is so-called leaked light, and there is a problem that the leaked light causes occurrence of a ghost (double image), a decrease in contrast, and the like.

Therefore, the present inventors have attempted to reduce the ghost by using a reflective circular polarizer as the reflective polarizer and increasing a circular polarization degree of reflected light. As a result, the pancake lens (folded-back optical system) including the reflective circular polarizer is effective in reducing the ghost.

However, according to the studies of the present inventors, the pancake lens manufactured using the reflective circular polarizer includes an individual in which a degree of the ghost is relatively small and an individual in which the degree is relatively large. That is, it has been found that the pancake lens manufactured using the reflective circular polarizer has a variation in size of the ghost, and it is an object to solve the variation.

The present invention has been made in view of the above-described problems, and an object of the present invention is to provide a virtual image display apparatus including a folded-back optical system, in which a variation in size of a ghost is reduced and occurrence of the ghost is stably reduced.

As a result of extensive studies to achieve the above-described object, the present inventors have completed the present invention. That is, the present inventors have found that the above-described object can be achieved by the following configurations.
[1] A virtual image display apparatus comprising at least: an image display device; and a folded-back optical system including a reflective circular polarizer, in which the reflective circular polarizer includes a cholesteric liquid crystal layer, and in the cholesteric liquid crystal layer, a degree of alignment of a liquid crystal compound is 0.5 or more on a surface on an image display device side, and a variation in a director orientation of the liquid crystal compound in an effective region is 30° or less.
[2] The virtual image display apparatus according to [1], in which the reflective circular polarizer includes a plurality of cholesteric liquid crystal layers.
[3] The virtual image display apparatus according to [2], in which the reflective circular polarizer includes at least a cholesteric liquid crystal layer formed of a first liquid crystal compound substantially consisting of a rod-like liquid crystal compound and a cholesteric liquid crystal layer formed of a second liquid crystal compound substantially consisting of a disk-like liquid crystal compound.
[4] The virtual image display apparatus according to any one of [1] to [3], in which at least a λ/4 wavelength plate and an absorptive linear polarizer are laminated in this order on a surface of the reflective circular polarizer on a viewing side.
[5] The virtual image display apparatus according to any one of [1] to [4], in which the reflective circular polarizer is formed in a curved-surface shape.

According to the present invention, it is possible to provide a virtual image display apparatus including a folded-back optical system, in which a variation in size of a ghost is small and occurrence of the ghost is stably reduced.

### BRIEF DESCRIPTION OF THE DRAWINGS

FIG. 1 is a schematic view showing an example of a virtual image display apparatus according to an embodiment of the present invention.

FIG. 2 is a schematic view showing an example of the virtual image display apparatus according to the embodiment of the present invention.

FIG. 3 is a schematic view showing an example of the virtual image display apparatus according to the embodiment of the present invention.

FIG. 4 is a Poincaré sphere diagram showing a change in polarization state of a ray transmitted through a reflective circular polarizer in the virtual image display apparatus according to the embodiment of the present invention.

FIG. 5 is a Poincaré sphere diagram showing a change in polarization state of a ray transmitted through the reflective circular polarizer in the virtual image display apparatus according to the embodiment of the present invention.

FIG. 6 is a Poincaré sphere diagram showing a change in polarization state of a ray transmitted through the reflective circular polarizer in the virtual image display apparatus according to the embodiment of the present invention.

FIG. 7 is a Poincaré sphere diagram showing a change in polarization state of a ray transmitted through the reflective circular polarizer in the virtual image display apparatus according to the embodiment of the present invention.

### DESCRIPTION OF THE PREFERRED EMBODIMENTS

Hereinafter, the virtual image display apparatus according to the embodiment of the present invention will be described in detail.

The description of configuration requirements below may be made based on typical embodiments or specific examples, but the present invention is not limited to such embodiments.

Any numerical range expressed using “to” in the present specification refers to a range including the numerical values before and after the “to” as a lower limit value and an upper limit value, respectively.

In the present specification, a term “orthogonal” does not denote that an angle formed by two axes or the like is exactly 90°, but denotes 90°+10°, preferably 90°+5°. In addition, a term “parallel” does not denote that the angle formed by two axes or the like is exactly 0°, but denotes 0°±10°, preferably 0°±5°.

Further, the angle “45°” does not denote that the angle formed by two axes or the like is exactly 45°, but denotes 45°±10° and preferably 45°±5°.

In the present specification, “absorption axis” denotes a polarization direction in which an absorbance is the maximum in a plane in a case where linearly polarized light is incident. In addition, the term “reflection axis” denotes a polarization direction in which reflectance is maximized in a plane in a case where linearly polarized light is incident. In addition, the term “transmission axis” denotes a direction orthogonal to the absorption axis or the reflection axis in a plane. Furthermore, the term “slow axis” denotes a direction in which refractive index is maximized in a plane. The term “fast axis” denotes a direction in which the refractive index is minimum in a plane, and is a direction orthogonal to the slow axis.

In the present specification, a retardation denotes an in-plane retardation unless otherwise specified, and is referred to as Re (λ). Here, Re (λ) represents an in-plane retardation at a wavelength λ, and the wavelength λ is 550 nm unless otherwise specified.

In addition, a retardation at the wavelength λ in a thickness direction is referred to as Rth (λ) in the present specification. The wavelength λ is set to 550 nm unless otherwise specified.

As Re (λ) and Rth (λ), values measured at the wavelength λ with AxoScan OPMF-1 (manufactured by Opto Science, Inc.) can be used. By inputting an average refractive index ((nx+ny+nz)/3) and a film thickness (d (μm)) in AxoScan, a slow axis direction) (°),

$$Re ( λ ) = R 0 ( λ ) , and$$

$$Rth ( λ ) = ( ( nx + ny ) / 2 - nz ) \times d is calculated .$$

### <Virtual Image Display Apparatus>

The virtual image display apparatus according to the embodiment of the present invention includes at least an image display device and a folded-back optical system including a reflective circular polarizer.

In addition, the reflective circular polarizer includes a cholesteric liquid crystal layer. Further, in the cholesteric liquid crystal layer, a degree of alignment of a liquid crystal compound is 0.5 or more on a surface on the image display device side, and a variation in director orientation of the liquid crystal compound in an effective region is 30° or less.

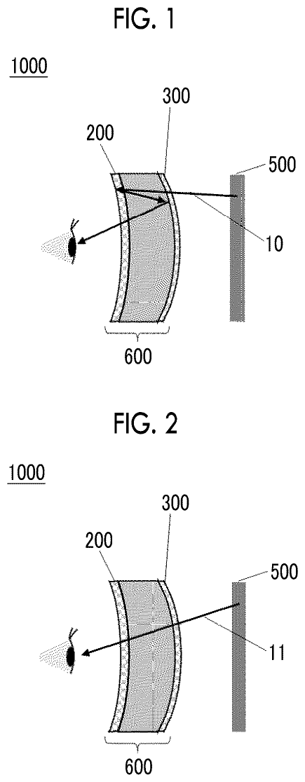

A mechanism in which the virtual image display apparatus according to the embodiment of the present invention generates a virtual image will be described with reference to FIG. 1.

FIG. 1 is a diagram conceptually showing an example of a virtual image display apparatus of the embodiment of the present invention.

A virtual image display apparatus 1000 shown in FIG. 1 includes an image display device 500 and a folded-back optical system 600. In the virtual image display apparatus 1000 according to the embodiment of the present invention, the folded-back optical system 600 includes a reflective circular polarizer 200. In addition, the folded-back optical system 600 in the example shown in the drawing includes a half mirror 300 in addition to the reflective circular polarizer 200.

The reflective circular polarizer 200 includes a cholesteric liquid crystal layer. The reflective circular polarizer 200, that is, the cholesteric liquid crystal layer reflects dextrorotatory circularly polarized light and transmits levorotatory circularly polarized light, for example. In addition, in the cholesteric liquid crystal layer, a degree of alignment of a liquid crystal compound is 0.5 or more on a surface on the image display device 500 side, and a variation in director orientation of the liquid crystal compound in an effective region is 30° or less.

A ray 10 (image) emitted from the image display device 500 is circularly polarized light. In the example shown in the drawing, for example, the image display device 500 emits dextrorotatory circularly polarized light.

For example, the image display device 500 includes an image display element (display panel), a retardation layer (λ/4 wavelength plate), a linear polarizer, and a retardation layer (λ/4 wavelength plate) in this order. In the image display device 500, light (unpolarized light) emitted from the image display element transmits through the retardation layer, is converted into linearly polarized light by the linear polarizer, is converted into dextrorotatory circularly polarized light by the retardation layer, and is emitted as the ray 10. The retardation layer immediately downstream of the image display element constitutes an anti-reflection film of the image display element together with the linear polarizer.

A part of the ray 10 (dextrorotatory circularly polarized light) emitted from the image display device 500 transmits through the half mirror 300 and is incident on the reflective circular polarizer 200.

As described above, the reflective circular polarizer 200 includes the cholesteric liquid crystal layer that selectively reflects dextrorotatory circularly polarized light. Accordingly, the ray 10 of dextrorotatory circularly polarized light incident on the reflective circular polarizer 200 is reflected by the reflective circular polarizer 200, the optical path is folded, the ray 10 is incident on the half mirror 300 again, and a part of the ray 10 is reflected by the half mirror 300.

In this reflection, the ray 10 is converted into levorotatory circularly polarized light and is incident on the reflective circular polarizer 200 again. As described above, the reflective circular polarizer 200 is the cholesteric liquid crystal layer that selectively reflects dextrorotatory circularly polarized light, and the ray 10 is converted into levorotatory circularly polarized light. Therefore, the ray 10 transmits through the reflective circular polarizer 200.

In this way, a part of the ray 10 is folded inside the folded-back optical system 600.

Here, in the folded-back optical system 600 shown in FIG. 1, the half mirror 300 acts as a concave mirror in a case of reflecting the ray 10 due to the curved-surface shape. Further, the folded-back optical system 600 may refract the ray 10 and generate lens power due to the shape thereof.

Due to these actions, the ray 10 emitted from the image display device 500 is substantially parallelized and reaches the eye of the user, and the user can visually recognize the image displayed on the image display device as a virtual image.

In the above example, the reflective circular polarizer 200 reflects dextrorotatory circularly polarized light and transmits levorotatory circularly polarized light, but the present invention is not limited thereto. That is, the reflective circular polarizer 200 may reflect levorotatory circularly polarized light and transmit dextrorotatory circularly polarized light. In this case, an image display device that emits levorotatory circularly polarized light may be used, and the effect of the present invention does not lose generality.

The same applies to the following description regarding the above point.

### <Principle of Occurrence of Ghost>

Next, a principle of occurrence of a ghost in the virtual image display apparatus 1000 will be described using a conceptual diagram of FIG. 2.

As described above, in the virtual image display apparatus 1000, a part of the ray 10 emitted from the image display device 500 transmits through the half mirror 300, is incident into the reflective circular polarizer 200, and is reflected by the reflective circular polarizer 200.

However, as schematically shown in FIG. 2, a part of the ray 10 emitted from the image display device 500 transmits through the half mirror 300, is not reflected by the reflective circular polarizer 200, and transmits through the reflective circular polarizer 200. Hereinafter, a part of the ray 10 is referred to as a ray 11. Since the ray 11 is not substantially parallelized and reaches the eye of the user at an optical path length different from that of the ray 10, the ray 11 is visually recognized as an image different from the virtual image visually recognized by the user, that is, as a ghost.

### <Principle of Occurrence of Variation in Size of Ghost>

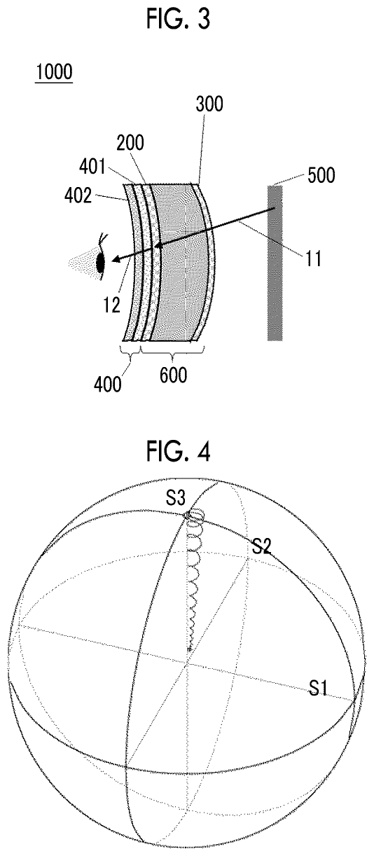

Although not shown in FIGS. 1 and 2 for the sake of simplicity, as shown in FIG. 3, the virtual image display apparatus 1000 according to the embodiment of the present invention includes an absorptive circular polarizer 400.

In the example shown in the drawing, the ray 10 emitted from the image display device 500 is dextrorotatory circularly polarized light. Accordingly, in a case where the ray 11 that is unnecessarily transmitted through the reflective circular polarizer 200 is incident into the reflective circular polarizer 200 for the first time, most of the ray 11 is dextrorotatory circularly polarized light.

Therefore, as conceptually shown in FIG. 3, by laminating the absorptive circular polarizer 400 that absorbs dextrorotatory circularly polarized light on the viewing side (user side) of the reflective circular polarizer 200, the ghost can be significantly reduced. The absorptive circular polarizer 400 can be produced by laminating a λ/4 wavelength plate (24 retardation layer) 401 and an absorptive linear polarizer 402, for example. In addition, since the absorptive circular polarizer 400 transmits levorotatory circularly polarized light, the absorptive circular polarizer 400 hardly affects the display quality of the virtual image visually recognized by the user.

On the other hand, it is also found that a part of the ray 11 may be converted into levorotatory circularly polarized light after being transmitted through the reflective circular polarizer 200. In FIG. 3, in order to distinguish the ray 11, which is mainly dextrorotatory circularly polarized light, from the ray converted from the dextrorotatory circularly polarized light 11 to the levorotatory circularly polarized light, the ray is referred to as a ray 12.

According to the studies by the present inventors, the light amount of the ray 12 varies greatly. It is presumed that the variation in the light amount of the ray 12 causes the variation in the size of the ghost in the virtual image display apparatus including the folded-back optical system.

Since the ray 12 is levorotatory circularly polarized light, the ray 12 cannot be absorbed by the absorptive circular polarizer 400 that absorbs dextrorotatory circularly polarized light. Accordingly, it is difficult to suppress the variation in the ghost caused by the ray 12 (levorotatory circularly polarized light) having a large variation in the light amount.

The present inventors presume a mechanism in which a part of the ray 11 is converted into levorotatory circularly polarized light (ray 12) by the reflective circular polarizer 200 as follows.

FIG. 4 conceptually shows a change in polarization state in a case where the ray 11 incident on the reflective circular polarizer 200 is transmitted through the reflective circular polarizer 200, using a Poincare sphere.

The ray 11 is dextrorotatory circularly polarized light in a case of being incident on the reflective circular polarizer 200. Therefore, the ray 11 is represented by a position (top of an S3 axis) of a point S3 in the Poincare sphere.

In addition, the reflective circular polarizer 200 selectively reflects the dextrorotatory circularly polarized light. Therefore, as the ray 11, which is mainly dextrorotatory circularly polarized light, travels inside the reflective circular polarizer 200, the light amount of transmitted light decreases. In the present specification, a distance from the center in the Poincare sphere represents the light amount. That is, in the present specification, the decrease in the light amount of transmitted light is described as a trajectory representing a change in polarization state approaching the center of the Poincare sphere while spiraling in the vicinity of the S3 axis as shown in FIG. 4 in the Poincare sphere.

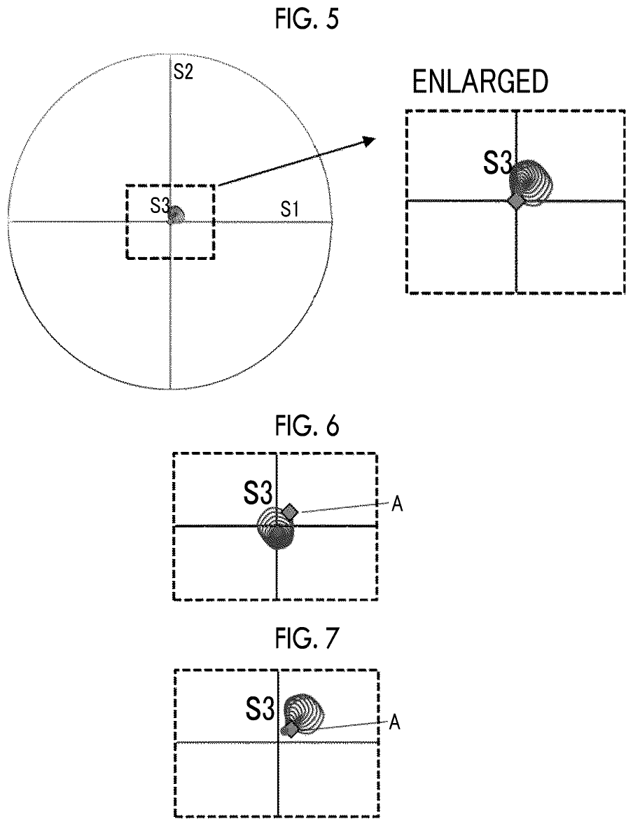

FIG. 5 is a view of the Poincare sphere of FIG. 4 as viewed in a direction of the point S3 (S3 axis).

In FIG. 5, it can be seen that the trajectory representing a change in polarization state spirals while being biased in a direction of a first quadrant as a whole. In FIG. 5, the first quadrant is a quadrant formed by the S1 axis and the S2 axis. The fact that the trajectory representing a change in polarization state is separated from the S3 axis means that a part of the ray 11 is converted into levorotatory circularly polarized light, that is, the ray 12.

The polarization state of the ray 11 changes depending on the optical action of the liquid crystal compound included in the cholesteric liquid crystal layer constituting the reflective circular polarizer 200. Here, according to the studies of the present inventors, a direction in which the trajectory representing a change in polarization state initially moves on the Poincare sphere is determined by the orientation of the director of the liquid crystal compound on the light incident surface side of the cholesteric liquid crystal layer.

Accordingly, the direction of the bias in FIG. 5 is generally determined by the orientation of the director of the liquid crystal compound on the light incident surface side of the cholesteric liquid crystal layer.

However, in general, the orientation of the director of the liquid crystal compound of the cholesteric liquid crystal layer may be various orientations. Therefore, the bias of the polarization state on the Poincare sphere is not constant, and this is presumed to cause a variation in the size of the ghost.

On the other hand, the ray 10 emitted from the image display device 500 is not strictly circularly polarized light and is generally elliptically polarized light. In this case, in a case where the polarization state of the ray 11 immediately before incidence on the reflective circular polarizer 200 is represented on the Poincare sphere, the polarization state is represented at a position slightly separated from the S3 axis (point S3) as shown in points A in FIGS. 6 and 7.

As shown in FIG. 6, in a case where the bias of the trajectory of the change in polarization state by the cholesteric liquid crystal layer on the Poincare sphere is an orientation in which the bias of the ray 11 is canceled, the proportion of the ray 11 converted into levorotatory circularly polarized light is small, and the ghost is also small. On the other hand, as shown in FIG. 7, in a case where the bias of the trajectory of the change in polarization state is an orientation in which the bias of the ray 11 is increased, the proportion of the ray 11 converted into levorotatory circularly polarized light is large, and the ghost is increased.

That is, by adjusting the bias of the trajectory of the change in polarization state by the cholesteric liquid crystal layer depending on the polarization state of the ray 10, the ghost can be reduced. Alternatively, by adjusting the polarization state of the ray 10 depending on the bias of the trajectory of the change in polarization state by the cholesteric liquid crystal layer, the ghost can be reduced.

For example, as described above, the direction of the bias of the trajectory of the change in polarization state by the cholesteric liquid crystal layer is generally determined by the orientation of the director of the liquid crystal compound on the light incident surface side of the cholesteric liquid crystal layer. Accordingly, by adjusting the orientation of the director of the liquid crystal compound on the light incident surface side of the cholesteric liquid crystal layer depending on the polarization state of the ray 10, the ghost can be reduced.

In the present invention, the variation in the size of the ghost has specifically two meanings.

The first variation in the size of the ghost is a variation in the size of the ghost for each individual of the cholesteric liquid crystal layer (reflective circular polarizer), that is, the virtual image display apparatus. That is, the variation in the size of the ghost is an individual difference between a plurality of members and devices.

The second variation in the size of the ghost is a variation in the size of the ghost in a plane of one cholesteric liquid crystal layer (reflective circular polarizer), that is, in a display image by one virtual image display apparatus. That is, the variation in the size of the ghost is, for example, a variation in which the ghost is small at the center in the up-down direction and the ghost is large at the upper part and the lower part in the displayed virtual image.

<Virtual Image Display Apparatus according to embodiment of Present Invention>

Based on the above-described estimation, the present inventors have estimated that the variation in the size of the ghost in the virtual image display apparatus can be reduced by controlling the orientation of the director of the liquid crystal compound on the light incident surface side of the cholesteric liquid crystal layer to be a certain orientation, and have completed the present invention.

That is, as described above, the generation of the levorotatory circularly polarized light that causes the ghost is caused by a change in the polarization state of the ray 11 which is dextrorotatory circularly polarized light transmitted through the cholesteric liquid crystal layer. In addition, a direction in which a trajectory representing the change in the polarization state initially moves on the Poincare sphere is determined by the orientation of the director of the liquid crystal compound on the light incident surface side of the cholesteric liquid crystal layer. Therefore, a direction of the bias of the polarized light in FIG. 5 is generally determined by the orientation of the director of the liquid crystal compound on the light incident surface side of the cholesteric liquid crystal layer. The variation in the orientation of the director causes the variation in the size of the ghost.

Accordingly, in a case where there is no variation in the orientation of the director of the liquid crystal compound on the light incident surface side of the cholesteric liquid crystal layer, the change in the polarization state of the circularly polarized light (elliptically polarized light) transmitted through the reflective circular polarizer 200 can be made uniform, and the variation in the ghost can be reduced.

The virtual image display apparatus according to the embodiment of the present invention includes at least an image display device and a folded-back optical system including a reflective circular polarizer, in which the reflective circular polarizer includes a cholesteric liquid crystal layer, and in the cholesteric liquid crystal layer, a degree of alignment of a liquid crystal compound is 0.5 or more on a surface on an image display device side, that is, a surface on which a ray 10 (ray 11) is incident, and a variation in a director orientation of the liquid crystal compound in an effective region is 30° or less.

With the configuration, the virtual image display apparatus according to the embodiment of the present invention can reduce the variation in the size of the ghost in the virtual image display apparatus.

The effective region refers to a region through which the ray from the image display device is transmitted in a case where the user visually recognizes the displayed virtual image, in an in-plane region of the reflective circular polarizer incorporated in the virtual image display apparatus.

In the virtual image display apparatus according to the embodiment of the present invention, in a case where the degree of alignment of the liquid crystal compound of the cholesteric liquid crystal layer on the surface on the image display device side is less than 0.5, the variation in the ghost cannot be sufficiently reduced, the circularly polarized light to be reflected (for example, dextrorotatory circularly polarized light) cannot be sufficiently reflected, and the ghost increases, which causes inconvenience.

The degree of alignment of the liquid crystal compound of the cholesteric liquid crystal layer on the surface on the image display device side is preferably 0.6 or more and more preferably 0.65 or more.

In the present invention, the degree of alignment of the liquid crystal compound of the cholesteric liquid crystal layer on the surface on the image display device side is preferably as high as possible, and the upper limit of 1 is most preferable.

In the virtual image display apparatus according to the embodiment of the present invention, in a case where the variation in the director orientation of the liquid crystal compound in the effective region of the cholesteric liquid crystal layer on the surface on the image display device side exceeds 30°, the variation in the ghost cannot be sufficiently reduced, which causes inconvenience.

The variation in the director orientation of the liquid crystal compound in the effective region of the cholesteric liquid crystal layer on the surface on the image display device side is preferably 10° or less and more preferably 5° or less.

In the present invention, the variation in the director orientation of the liquid crystal compound in the effective region of the cholesteric liquid crystal layer on the surface on the image display device side is preferably as small as possible, and 0° is most preferable.

In addition, according to the studies of the present inventors, in a case where the cholesteric liquid crystal layer on the image display device side in the reflective circular polarizer is a layer consisting of a rod-like liquid crystal compound, the orientation of the polarization axis of the elliptically polarized light emitted from the image display device at a wavelength of 550 nm and the orientation of the director of the liquid crystal compound on the surface of the cholesteric liquid crystal layer on the image display device side preferably form an angle of 45° to 90° and more preferably form an angle of 55° to 80°.

In addition, in a case where the cholesteric liquid crystal layer on the image display device side in the reflective circular polarizer is a layer consisting of a disk-like liquid crystal compound, the orientation of the polarization axis of the elliptically polarized light emitted from the image display device at a wavelength of 550 nm and the orientation of the director of the liquid crystal compound on the surface of the cholesteric liquid crystal layer on the image display device side preferably form an angle of 0° to 45° and more preferably form an angle of 10° to 35°.

In a case where the angle is within the above-described range, the position of the elliptically polarized light on the Poincare sphere is a position where the bias of the polarization state due to the cholesteric liquid crystal layer is canceled, and the ghost can be minimized.

Furthermore, the average value of the ellipticities of the elliptically polarized light emitted from the image display device at a wavelength of 450 to 650 nm is preferably 0.8 to 0.99. In a case where the ellipticity is within the above-described range, the ghost can be further reduced, which is preferable. The average value of the ellipticities is more preferably 0.85 to 0.98 and still more preferably 0.93 to 0.98.

The orientation of the elliptical axis of the elliptically polarized light represents the orientation of the major axis of the ellipse in the elliptical orbit drawn by the change in the electric field in the elliptically polarized light. In addition, the ellipticity represents the ratio of the length of the major axis to the length of the minor axis in the elliptical orbit.

The orientation of the elliptical axis and the ellipticity of the elliptically polarized light emitted from the image display device can be obtained, for example, by peeling off the circular polarizer from the surface of the image display device and measuring the elliptically polarized light at a wavelength of 550 nm using AxoScan OPMF-1 (manufactured by Opto Science, Inc.).

### <Reflective Circular Polarizer>

The reflective circular polarizer is a polarizer that allows transmission of dextrorotatory circularly polarized light or levorotatory circularly polarized light and reflects circularly polarized light having a revolving direction opposite to that of the transmitted circularly polarized light.

The reflective circular polarizer included in the virtual image display apparatus according to the embodiment of the present invention includes a cholesteric liquid crystal layer. The cholesteric liquid crystal layer is a liquid crystal phase obtained by fixing a cholesterically aligned liquid crystal phase (cholesteric liquid crystalline phase).

As is well known, the cholesteric liquid crystal layer has a helical structure in which the liquid crystal compound is helically revolved and laminated. In the helical structure, a configuration in which the liquid crystal compound is helically rotated once (rotated by) 360° and laminated is set as single helical period (helical period (helical pitch)), and the helically revolved liquid crystal compounds are laminated a plurality of periods.

The cholesteric liquid crystal layer reflects dextrorotatory circularly polarized light or levorotatory circularly polarized light in a specific wavelength range and allows transmission of the other light depending on the length of the helical period and the helical revolving direction (sense) of the liquid crystal compound.

Therefore, in a case where the virtual reality display apparatus displays a color image, the reflective circular polarizer may include, for example, a plurality of cholesteric liquid crystal layers including a cholesteric liquid crystal layer that has a central wavelength of selective reflection for red light, a cholesteric liquid crystal layer that has a central wavelength of selective reflection for green light, and a cholesteric liquid crystal layer that has a central wavelength of selective reflection for blue light.

In addition, the reflective circular polarizer may include a support and an alignment film for aligning the liquid crystal compound in the cholesteric liquid crystal layer, in addition to the cholesteric liquid crystal layer.

In the virtual image display apparatus according to the embodiment of the present invention, the reflective circular polarizer included in the folded-back optical system includes a cholesteric liquid crystal layer. In the cholesteric liquid crystal layer, a degree of alignment of the liquid crystal compound is 0.5 or more on a surface on an image display device side, and a variation in director orientation of the liquid crystal compound in an effective region is 30° or less.

In the surface of the cholesteric liquid crystal layer on the image display device side, the above-described degree of alignment and the above-described variation in director orientation can be realized by performing an alignment treatment such that an alignment direction of the liquid crystal compound is aligned in one direction in a case of forming the cholesteric liquid crystal layer.

In the alignment treatment, for example, a photo-alignment film is applied to a support, the photo-alignment film is irradiated with polarized ultraviolet rays or the like, a liquid crystal composition including a liquid crystal compound is applied to the photo-alignment film, the liquid crystal compound is aligned in a state of a cholesteric liquid crystalline phase, and the liquid crystal compound is cured to fix the cholesteric liquid crystalline phase, whereby a cholesteric liquid crystal layer can be formed. The director orientation of the liquid crystal compound can be controlled by the polarization axis orientation of polarized light with which the photo-alignment film is irradiated. In addition, the alignment treatment can be similarly performed by rubbing a support or an alignment film applied on the support.

An alignment treatment surface of the cholesteric liquid crystal layer formed as described above, that is, a surface on the alignment film side is set as an image display device side, that is, an incidence side of a ray 10 (ray 11). As a result, in the surface of the cholesteric liquid crystal layer on the image display device side, the degree of alignment of the liquid crystal compound can be 0.5 or more, and the variation in director orientation of the liquid crystal compound in the effective region can be 30° or less.

The degree of alignment of the liquid crystal compound and the director orientation on the surface of the cholesteric liquid crystal layer can be measured by second harmonic generation (SHG) measurement or the like.

Here, the degree of alignment is an indicator representing a local order degree of the liquid crystal compound, and is also referred to as an order parameter. The degree of alignment may be 0.5 or more in a case where SHG measurement is performed at five positions in the effective region in a case where the reflective circular polarizer is incorporated into the virtual image display apparatus.

In addition, the director orientation represents a major axis direction of the liquid crystal compound. The variation in director orientation of the liquid crystal compound in the effective region is a maximum value of an angle between the director orientations at different positions in a case where SHG measurement is performed at five positions in the effective region in a case where the reflective circular polarizer is incorporated into the virtual image display apparatus and the local director orientation is measured.

Specifically, the photo-alignment film is an alignment film containing a photo-alignment material.

Examples of the photo-alignment material used for a photo-alignment film include the azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, the aromatic ester compounds described in JP2002-229039A, the maleimide and/or alkenyl-substituted nadimide compounds having photo-alignment units described in JP2002-265541A and JP2002-317013A, the photocrosslinkable silane derivatives described in JP4205195B and JP4205198B, the photocrosslinkable polyimides, polyamides, and esters described in JP2003-520878A, JP2004-529220A, and JP4162850B, and the photodimerizable compounds, in particular, a cinnamate compound, a chalcone compound, and a coumarin compound, described in JP1997-118717A (JP-H9-118717A), JP1998-506420A (JP-H10-506420A), JP2003-505561A, WO2010/150748A, JP2013-177561A, and JP2014-12823A. Preferred examples of the photo-alignment material include an azo compound, a photo-crosslinking polyimide, a polyamide, an ester, a cinnamate compound, and a chalcone compound.

The photo-alignment film can be formed by applying a composition containing the above-described photo-alignment material to form a coating film, irradiating the coating film with light, and applying an orientation restriction force. It is noted that it is preferable that the coating film is irradiated with polarized light in a direction perpendicular to the surface of the coating film or in a direction tilted from the perpendicular direction. In addition, the coating film may be irradiated with non-polarized light in a direction tilted from the direction perpendicular to the surface of the coating film.

It is noted that the composition containing the above-described photo-alignment material may contain a component other than the photo-alignment material that can form a photo-alignment film.

The refractive index of the photo-alignment film can be adjusted depending on the type of the above-described photo-alignment material. In addition, the refractive index of the photo-alignment film can be adjusted by other components that may be contained together with the above-described photo-alignment material.

It is noted that the photo-alignment film is a layer having a liquid crystal alignment ability. Specifically, the liquid crystal alignment ability is an alignment imparting ability to a liquid crystal compound.

### (Method of Forming Cholesteric Liquid Crystal Layer)

The cholesteric liquid crystal layer can be formed by fixing a cholesteric liquid crystalline phase in a layer shape.

The structure in which a cholesteric liquid crystalline phase is fixed may be a structure in which the alignment of the liquid crystal compound as a cholesteric liquid crystalline phase is immobilized. Typically, the structure in which a cholesteric liquid crystalline phase is immobilized is preferably a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which the cholesteric liquid crystalline phase is fixed is not particularly limited as long as the optical characteristics of the cholesteric liquid crystalline phase are maintained, and the liquid crystal compound in the cholesteric liquid crystal layer does not necessarily exhibit liquid crystallinity. For example, the molecular weight of the polymerizable liquid crystal compound may be increased by the curing reaction and the liquid crystallinity may be lost.

Examples of a material used for forming the cholesteric liquid crystal layer obtained by fixing the cholesteric liquid crystalline phase include a liquid crystal composition containing a liquid crystal compound. The liquid crystal compound is preferably a polymerizable liquid crystal compound.

Furthermore, the liquid crystal composition used for forming the cholesteric liquid crystal layer may further include a surfactant and a chiral agent.

### —Polymerizable Liquid Crystal Compound—

The polymerizable liquid crystal compound may be a rod-like liquid crystal compound or a disk-like liquid crystal compound.

Examples of the rod-like polymerizable liquid crystal compound forming the cholesteric liquid crystalline phase include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolane compound, or an alkenylcyclohexylbenzonitrile compound is preferably used. Polymer liquid crystal compounds can also be used as well as low-molecular liquid crystal compounds.

The polymerizable liquid crystal compound is obtained by introducing a polymerizable group into the liquid crystal compound. Examples of the polymerizable group include an unsaturated polymerizable group, an epoxy group, and an aziridinyl group; and an unsaturated polymerizable group is preferable, and an ethylenically unsaturated polymerizable group is more preferable. The polymerizable group can be introduced into the molecules of the liquid crystal compound using various methods. The number of polymerizable groups included in the polymerizable liquid crystal compound is preferably 1 to 6 and more preferably 1 to 3.

Examples of the polymerizable liquid crystal compound include compounds described in “Makromol. Chem., vol. 190, p. 2255 (1989), Advanced Materials, vol. 5, p. 107 (1993)”, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-016616A (JP-H6-016616A), JP1995-110469A (JP-H7-110469A), JP1999-080081A (JP-H11-080081A), JP2001-328973A, and the like. Two or more polymerizable liquid crystal compounds may be used in combination. In a case where two or more kinds of polymerizable liquid crystal compounds are used in combination, an alignment temperature can be decreased.

In addition, as a polymerizable liquid crystal compound other than the above-described examples, for example, such a cyclic organopolysiloxane compound having a cholesteric phase as described in JP1982-165480A (JP-S57-165480A) can be used. Further, as the above-described polymer liquid crystal compound, for example, a polymer in which a liquid crystal mesogenic group is introduced into the main chain, a side chain, or both the main chain and a side chain, a polymer cholesteric liquid crystal in which a cholesteryl group is introduced into a side chain, such a liquid crystal polymer as described in JP1997-133810A (JP-H9-133810A), and such a liquid crystal polymer as described in JP1999-293252A (JP-H11-293252A) can be used.

### —Disk-Like Liquid Crystal Compound—

As the disk-like liquid crystal compound, for example, compounds described in JP2007-108732A and JP2010-244038A can be preferably used.

From the viewpoint of increasing the reflectance of circularly polarized light of the reflective circular polarizer and reducing the ghost, it is preferable that the reflective circular polarizer includes at least a cholesteric liquid crystal layer formed of a first liquid crystal compound substantially consisting of a rod-like liquid crystal compound and a cholesteric liquid crystal layer formed of a second liquid crystal compound substantially consisting of a disk-like liquid crystal compound.

The above-described “substantially consisting of a rod-like liquid crystal compound” means that the rod-like liquid crystal compound is 95% by mass or more of the liquid crystal compound contained in the cholesteric liquid crystal layer R. The above-described “substantially consisting of a disk-like liquid crystal compound” means that the disk-like liquid crystal compound is 95% by mass or more of the liquid crystal compound contained in the cholesteric liquid crystal layer D.

In addition, the addition amount of the polymerizable liquid crystal compound in the liquid crystal composition is preferably 75% to 99.9 mass %, more preferably 80% to 99 mass %, and still more preferably 85% to 90 mass % with respect to the solid content mass (mass excluding a solvent) of the liquid crystal composition.

### —Surfactant—

The liquid crystal composition used in forming the cholesteric liquid crystal layer may contain a surfactant.

It is preferable that the surfactant is a compound that can function as an alignment control agent contributing to the stable or rapid alignment of a cholesteric liquid crystalline phase. Examples of the surfactant include a silicone surfactant and a fluorine-based surfactant. Among these, a fluorine-based surfactant is preferable.

Specific examples of the surfactant include compounds described in paragraphs [0082] to [0090] of JP2014-119605A, compounds described in paragraphs [0031] to [0034] of JP2012-203237A, exemplary compounds described in paragraphs [0092] and [0093] of JP2005-099248A, exemplary compounds described in paragraphs [0076] to [0078] and paragraphs [0082] to [0085] of JP2002-129162A, and fluorine (meth)acrylate polymers described in paragraphs to of JP2007-272185A.

The surfactant may be used alone or in combination of two or more kinds thereof.

The fluorine-based surfactant is preferably a compound described in paragraphs to of JP2014-119605A.

The adding amount of the surfactant in the liquid crystal composition is preferably 0.01 to 10% by mass, more preferably 0.01 to 5% by mass, and still more preferably 0.02 to 1% by mass with respect to the total mass of the liquid crystal compound.

### —Chiral Agent (Optically Active Compound)—

The chiral agent has a function of causing a helical structure of a cholesteric liquid crystalline phase to be formed. The chiral agent may be selected depending on the purpose because a helical twisted direction or a helical period derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may also have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

Further, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photo mask after coating and alignment, which is preferable. As the photoisomerizable group, an isomerizable site of a compound exhibiting photochromic properties, an azo group, an azoxy group, or a cinnamoyl group is preferable.

Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01% to 200% by mole, and more preferably 1% to 30% by mole with respect to the molar content of the liquid crystal compound.

### —Polymerization Initiator—

In a case where the liquid crystal composition contains a polymerizable compound, it is preferable that the liquid crystal composition contains a polymerization initiator. In an aspect where a polymerization reaction progresses with ultraviolet irradiation, it is preferable that the polymerization initiator is a photopolymerization initiator which can initiate a polymerization reaction with ultraviolet irradiation.

Examples of the photopolymerization initiator include α-carbonyl compounds (described in U.S. Pat. Nos. 2,367,661A and 2,367,670A), acyloin ether (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine compounds and phenazine compounds (described in JP1985-105667A (JP-S60-105667A) and U.S. Pat. No. 4,239,850A), and oxadiazole compounds (described in U.S. Pat. No. 4,212,970A).

The content of the photopolymerization initiator in the liquid crystal composition is preferably 0.1 to 20% by mass and more preferably 0.5 to 12% by mass with respect to the content of the liquid crystal compound.

### —Crosslinking Agent—

In order to improve a film hardness after curing and to improve durability, the liquid crystal composition may include any crosslinking agent. As the crosslinking agent, a crosslinking agent which cures the liquid crystal composition with ultraviolet rays, heat, humidity, and the like can be suitably used.

The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3-(1-aziridinyl) propionate] and 4,4-bis(ethyleneiminocarbonylamino); isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a well-known catalyst can be used in accordance with reactivity of the crosslinking agent, and it is possible to improve the productivity, in addition to the improvement of the film hardness and durability. These may be used alone or in combination of two or more kinds thereof.

A content of the crosslinking agent is preferably 3% to 20% by mass, and more preferably 5% to 15% by mass with respect to the mass of solid content of the liquid crystal composition. In a case where the content of the crosslinking agent is in the above-described range, an effect of improving a crosslinking density can be easily obtained, and the stability of a cholesteric liquid crystalline phase is further improved.

### —Other Additives—

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

The liquid crystal composition is preferably used as a liquid in forming the cholesteric liquid crystal layer.

The liquid crystal composition may contain a solvent. The solvent is not particularly limited and can be appropriately selected depending on the purpose. An organic solvent is preferable.

The organic solvent is not limited and may be appropriately selected according to the purpose, and examples thereof include ketones, alkyl halides, amides, sulfoxides, heterocyclic compounds, hydrocarbons, esters, and ethers. These may be used alone or in combination of two or more kinds thereof. Among these, the ketone is preferable in consideration of an environmental burden.

In a case of forming the cholesteric liquid crystal layer, it is preferable that the cholesteric liquid crystal layer is formed by applying the liquid crystal composition to a surface where the cholesteric liquid crystal layer is to be formed, aligning the liquid crystal compound to a state of the cholesteric liquid crystalline phase, and then curing the liquid crystal compound.

That is, in a case where the cholesteric liquid crystal layer is formed on the alignment film, it is preferable that the cholesteric liquid crystal layer obtained by fixing a cholesteric liquid crystalline phase is formed by applying the liquid crystal composition to the alignment film, aligning the liquid crystal compound to a state of a cholesteric liquid crystalline phase, and curing the liquid crystal compound.

In addition, in a case where a plurality of cholesteric liquid crystal layers are laminated, the liquid crystal composition is applied to the already formed cholesteric liquid crystal layer, the liquid crystal compound is aligned in a state of a cholesteric liquid crystalline phase, and then the liquid crystal compound is cured to form a second cholesteric liquid crystal layer.

For the application of the liquid crystal composition, a printing method such as ink jet or scroll printing or a well-known method such as spin coating, bar coating, or spray coating capable of uniformly applying liquid to a sheet-like material can be used.

The applied liquid crystal composition is dried and/or heated as necessary, and then cured to form a cholesteric liquid crystal layer. In the drying and/or heating step, the liquid crystal compound in the liquid crystal composition only has to be aligned to a cholesteric liquid crystalline phase. In a case where heating is performed, the heating temperature is preferably 200° C. or lower and more preferably 130° C. or lower.

The aligned liquid crystal compound is optionally further polymerized. The polymerization may be thermal polymerization or photopolymerization by light irradiation, but photopolymerization is preferable. It is preferable to use ultraviolet rays for the light irradiation. An irradiation energy is preferably 20 mJ/cm² to 50 J/cm² and more preferably 50 to 1,500 mJ/cm². In order to promote a photopolymerization reaction, the light irradiation may be performed under the heating conditions or the nitrogen atmosphere. The wavelength of ultraviolet rays to be emitted is preferably 250 to 430 nm.

The thickness of the cholesteric liquid crystal layer is not particularly limited, and the thickness with which a required light reflectance can be obtained may be appropriately set depending on the light reflectance required for the cholesteric liquid crystal layer, the material for forming the cholesteric liquid crystal layer, and the like.

### <Other Layers>

he absorptive linear polarizer,

As illustrated in FIG. 3, the virtual image display apparatus according to the embodiment of the present invention may include a λ/4 wavelength plate 401 and an absorptive linear polarizer 402 on a surface of the reflective circular polarizer on the viewing side in this order.

In a case where the λ/4 wavelength plate 401 and the absorptive linear polarizer 402 are combined, the combination can act as the absorptive circular polarizer 400. For example, in a case where the reflective circular polarizer reflects dextrorotatory circularly polarized light, the dextrorotatory circularly polarized light that is not completely reflected by the reflective circular polarizer is converted into linearly polarized light by the λ/4 wavelength plate and is further absorbed by the absorptive linear polarizer, so that the ghost can be reduced, which is preferable.

A material constituting the λ/4 wavelength plate is not particularly limited, and examples thereof include a liquid crystal compound and a polymer. By aligning the liquid crystal material to exhibit refractive index anisotropy, the liquid crystal compound can form a retardation layer. The polymer can form a λ/4 wavelength plate by exhibiting refractive index anisotropy by stretching a polymer film obtained by casting, coating, or the like. The λ/4 wavelength plate is preferably a layer formed of a liquid crystal compound, and more preferably a layer formed of a liquid crystal compound having a polymerizable group.

The liquid crystal compound used for the λ/4 wavelength plate is preferably a liquid crystal compound having a polymerizable group.

The liquid crystal compound may be a liquid crystal compound exhibiting any of forward wavelength dispersibility or reverse wavelength dispersibility. In a case where a retardation layer exhibiting characteristics of a broadband λ/4 wavelength plate is used as a single film, a liquid crystal compound exhibiting reverse wavelength dispersibility is preferable, and a liquid crystal compound having two or more polymerizable groups and exhibiting reverse wavelength dispersibility is more preferable.

In the present specification, the “liquid crystal compound exhibiting reverse wavelength dispersibility” refers to a compound in which, in a case where an in-plane retardation (Re) value at a specific wavelength (visible light range) of an optically anisotropic layer produced using the compound is measured, the above-described relationships of Expression (A) and Expression (B) are satisfied.

$$Re ( 450 ) / Re ( 550 ) < 1. \qquad Expression ( A )$$

$$Re ( 650 ) / Re ( 550 ) > 1. \qquad Expression ( B )$$

As described above, the λ/4 wavelength plate is preferably a layer formed of a liquid crystal compound having a polymerizable group, and more preferably a layer formed by fixing an alignment state of a liquid crystal compound having a polymerizable group.

The alignment state that can be adopted by the liquid crystal compound having a polymerizable group is not particularly limited, and examples thereof include homogeneous alignment, homeotropic alignment, twisted alignment, cholesteric alignment, hybrid alignment, and tilt alignment. The hybrid alignment is specifically an alignment in which a tilt angle of a liquid crystal compound continuously changes from one surface toward another surface. In addition, the tilt alignment is specifically an alignment in which a tilt angle of a liquid crystal compound is constant from one surface toward another surface. The twisted alignment represents an alignment state in which the liquid crystal compound is twisted with respect to the thickness direction as a rotation axis, and in a case where the liquid crystal compound is subject to twisted alignment and aligned and has a predetermined tilt angle (tilt angle is more than) 0°, the twisted alignment corresponds to a twisted hybrid alignment. In the present specification, the twisted alignment corresponds to an aspect in which the twisted angle of the liquid crystal compound is less than 360°, and the cholesteric alignment corresponds to an aspect in which the twisted angle of the liquid crystal compound is 360° or more.

The λ/4 wavelength plate formed of a liquid crystal compound may have a plurality of regions where alignment states of the liquid crystal compound are different from each other along the thickness direction. For example, the λ/4 wavelength plate may have a region in which a state where a liquid crystal compound is homogeneously aligned is fixed and a region in which a state where a liquid crystal compound is subject to twisted alignment is fixed, along the thickness direction.

A thickness of the λ/4 wavelength plate is not particularly limited, but is preferably 0.1 to 10.0 μm and more preferably 0.5 to 5.0 μm.

Specific examples of the configuration of the broadband λ/4 wavelength plate include a λ/4 wavelength plate including a retardation layer formed of a single layer, which is disclosed in WO2019/160016A, JP2020-173460A, WO2021/157694A, and the like, in which a liquid crystal compound exhibiting reverse wavelength dispersibility is used, and a λ/4 wavelength plate including a plurality of regions where alignment states of a liquid crystal compound are different from each other along the thickness direction, which is disclosed in WO2022/030308A, JP2022-184691A, and the like. In addition, examples of the configuration including a laminate of two or more retardation layers include a configuration in which a λ/4 retardation layer and a λ/2 retardation layer, which are disclosed in JP2001-108825A, JP2001-91741A, WO2013/137464A, and the like, are combined, and a configuration in which a retardation layer having a twisted alignment and another retardation layer, which are disclosed in JP2001-21720A, JP2014-209219A, WO2022/255105A, and the like, are combined.

In addition, in order to compensate for a change in phase difference with respect to obliquely incident rays, another retardation layer such as a positive C-plate and a negative C-plate may be further added to the λ/4 wavelength plate.

he absorptive linear polarizer,

The absorptive linear polarizer refers to a linear polarizer which absorbs linearly polarized light in an absorption axis direction of incident rays and allows transmission of linearly polarized light in a transmission axis direction.

As the absorptive linear polarizer, a known absorptive linear polarizer can be applied, and for example, a polarizer in which a dichroic substance is dyed in polyvinyl alcohol or other polymer resins and aligned by stretching, or a polarizer in which a dichroic substance is aligned by using alignment of a liquid crystal compound may be used.

The thickness of the absorptive linear polarizer is preferably 10 μm or less, more preferably 7 μm or less, and still more preferably 5 μm or less. In a case where the absorptive linear polarizer is thin, it is possible to prevent cracks, breakage, and the like from occurring in a case where the absorptive linear polarizer is stretched or formed.

In addition, a single plate transmittance of the absorptive linear polarizer is preferably 40% or more and more preferably 42% or more. Moreover, the degree of polarization is preferably 90% or more, more preferably 95% or more, and still more preferably 99% or more. In the present invention, the single plate transmittance and the degree of polarization of the absorptive linear polarizer are measured using an automatic polarizing film measuring device: VAP-7070 (manufactured by Jasco Corporation).

An angle between the transmission axis of the absorptive linear polarizer and the slow axis of the λ/4 wavelength plate is preferably 45° #10°, more preferably 45°±5°, and still more preferably 45°±3°.

As described above, it is also preferable that the absorptive linear polarizer is a light-absorbing anisotropic layer containing a liquid crystal compound and a dichroic substance. A linear polarizer containing a liquid crystal compound and a dichroic substance is preferable from the viewpoint that the thickness thereof can be reduced and cracks, breakage, and the like are unlikely to occur even in a case where the laminated optical film is stretched, formed, or the like.

A thickness of the light-absorbing anisotropic layer is not particularly limited, but from the viewpoint of thinning, it is preferably 0.1 to 8 μm and more preferably 0.3 to 5 μm.

The linear polarizer containing a liquid crystal compound and a dichroic substance can be produced with reference to, for example, JP2020-023153A. From the viewpoint of improving the polarization degree of the linear polarizer, the degree of alignment of the dichroic substance in the light-absorbing anisotropic layer is preferably 0.95 or greater and more preferably 0.97 or greater.

A liquid crystal compound which does not exhibit dichroic properties in the visible region is preferable as a liquid crystal compound contained in a composition used for forming the light-absorbing anisotropic layer, which is used to form the light-absorbing anisotropic layer.

As such a liquid crystal compound, both a low-molecular-weight liquid crystal compound and a polymer liquid crystal compound can be used. Here, the “low-molecular-weight liquid crystal compound” refers to a liquid crystal compound having no repeating unit in the chemical structure. In addition, “polymer liquid crystal compound” refers to a liquid crystal compound including a repeating unit in a chemical structure.

Examples of the polymer liquid crystal compound include thermotropic liquid crystal polymers described in JP2011-237513A. In addition, it is preferable that the polymer liquid crystal compound has a crosslinkable group (such as an acryloyl group or a methacryloyl group) at a terminal.

The liquid crystal compound may be used alone or in combination of two or more kinds thereof. It is also preferable that the polymer liquid crystal compound and the low-molecular-weight liquid crystal compound are used in combination.

A content of the liquid crystal compound is preferably 25 to 2000 parts by mass, more preferably 33 to 1000 parts by mass, and still more preferably 50 to 500 parts by mass with respect to 100 parts by mass of a content of the dichroic substance in the present composition. In a case where the content of the liquid crystal compound is within the above-described range, the degree of alignment of the polarizer is further improved.

The dichroic substance contained in the composition for forming the light-absorbing anisotropic layer, which is used to form the light-absorbing anisotropic layer, is not particularly limited, and examples thereof include a visible light absorbing substance (dichroic coloring agent), an ultraviolet absorbing substance, an infrared absorbing substance, a nonlinear optical substance, and a carbon nanotube. In addition, known dichroic substances (dichroic coloring agents) of the related art can be used.

In the absorptive linear polarizer, two or more kinds of dichroic substances may be used in combination. For example, from the viewpoint of obtaining a high polarization degree over a wider wavelength range, it is preferable that at least one dichroic substance having a maximal absorption wavelength in a wavelength range of 370 to 550 nm and at least one dichroic substance having a maximal absorption wavelength in a wavelength range of 500 to 700 nm are used in combination.

The reflective circular polarizer, the λ/4 wavelength plate, and the absorptive linear polarizer used in the virtual image display apparatus according to the embodiment of the present invention may include a support, an alignment layer, and/or the like.

Alternatively, the reflective circular polarizer, the λ/4 wavelength plate, and the absorptive linear polarizer used in the virtual image display apparatus according to the embodiment of the present invention may include a support and/or an alignment layer during the production, and the support or the alignment layer may be finally peeled off. That is, the support and the alignment layer may be a temporary support that is finally peeled off and removed.

It is preferable to peel off and remove the temporary support since the virtual image display apparatus can be made thinner and the adverse effect of the phase difference of the temporary support on the degree of polarization of the transmitted light can be eliminated.

The type of the support is not particularly limited, but it is preferable that the support is transparent to visible light. Examples of the support include films (sheet-like materials) consisting of polyolefins such as triacetyl cellulose, a polyethylene terephthalate film, polyethylene, polypropylene, and a norbornene-based polymer; a cyclic polyolefin-based resin; polyvinyl alcohol; polyethylene terephthalate; acrylic resins such as polymethacrylic acid ester and polyacrylic acid ester; polyethylene naphthalate; polycarbonate; polysulfone; polyether sulfone; polyether ketone; and polyphenylene sulfide and polyphenylene oxide.

In addition, as the support, a commercially available product can also be used. Examples of the commercially available product include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type and LUMIRROR FX10, and LUMIRROR SF20 (TORAY INDUSTRIES, INC.), HK-53A (Higashiyama Film Co., Ltd.), TFLEX FT3 (Teijin DuPont Films), ESCHINA and SCA40 (Sekisui Chemical Co., Ltd.), Zeonor film (Optes Co., Ltd.), and Arton film (JSR Corporation).

In addition, in order to minimize the influence on various sensors incorporated in an optical system such as a virtual reality display apparatus and an electronic finder, in which near-infrared light is used as a light source, such as eye tracking, expression recognition, and iris authentication, it is preferable that the reflective circular polarizer, the λ/4 wavelength plate, and the absorptive linear polarizer used in the virtual image display apparatus according to the embodiment of the present invention are transmissive to near-infrared light.

### (Other Functional Layers)

The virtual image display apparatus according to the embodiment of the present invention may include other functional layers in addition to the reflective circular polarizer, the λ/4 wavelength plate, and the absorptive linear polarizer.

Suitable examples of these functional layers include a positive C-plate and an antireflection layer, and it is preferable that the virtual image display apparatus according to the embodiment of the present invention includes these functional layers.

### (Folded-Back Optical System)

It is preferable that the reflective circular polarizer, the λ/4 wavelength plate, and the absorptive linear polarizer used in the virtual image display apparatus according to the embodiment of the present invention are bonded to a surface of a lens to form a folded-back optical system. In this case, it is preferable that a half mirror is formed on a surface of the lens opposite to a surface to which the reflective circular polarizer is bonded.

In addition, the reflective circular polarizer, the λ/4 wavelength plate, and the absorptive linear polarizer may be formed in a curved shape in accordance with a surface shape of the lens. From the viewpoint of reducing distortion and aberration of an image, it is preferable that these members are formed in a curved shape in accordance with the surface shape of the lens.

A method of forming the reflective circular polarizer, the λ/4 wavelength plate, and the absorptive linear polarizer in a curved shape is not limited, and various known methods can be used depending on a forming material, a layer configuration, and the like of the reflective circular polarizer or the like.

The lens is not limited, and various known lenses can be used. Examples of the lens include a convex lens and a concave lens. As the convex lens, for example, a biconvex lens, a plano-convex lens, a convex meniscus lens, or the like can be used. As the concave lens, for example, a biconcave lens, a plano-concave lens, a concave meniscus lens, or the like can be used.

As a material of the lens, a material transparent to visible light, such as glass, crystal, and plastic, can be used.

Since birefringence of the lens causes rainbow unevenness and leaked light, it is preferable that the birefringence is small, and a material having substantially zero birefringence is more preferable.

### <Image Display Device>

In the virtual image display apparatus according to the embodiment of the present invention, the image display device (image display element (display panel)) is not limited, and various known image display devices used in the virtual image display apparatus or the like can be used.

Examples of the image display device include a liquid crystal display device (liquid crystal display (LCD)), an organic electroluminescent display device (organic light emitting diode (OLED)), a cathode-ray tube (CRT), an electronic paper, a light emitting diode (LED) display device, a micro LED display device, a digital light processing (DLP), and a micro-electro-mechanical systems (MEMS) type display device.

In the virtual image display apparatus according to the embodiment of the present invention, the image display device may include an optical element such as a retardation layer (λ/4 wavelength plate) and a linear polarizer as necessary as described above. In a case where the image display element emits linearly polarized light such as a liquid crystal display, the linear polarizer is not necessary.

### EXAMPLES

Hereinafter, the present invention will be described in more detail based on Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### [Preparation of Coating Liquid for Reflective Layer]

### [Coating Liquid R-1 for Reflective Layer]

A composition shown below was stirred and dissolved in a container held at 70° C. to prepare a coating liquid R-1 for a reflective layer. Here, R represents a coating liquid containing a rod-like liquid crystal compound.

Coating liquid R-1 for reflective layer

| | | |
|---|---|---|
| Methyl ethyl ketone | 120.9 | parts by mass |
| Cyclohexanone | 21.3 | parts by mass |
| Mixture X of rod-like liquid crystal compounds shown below | 100.0 | parts by mass |
| Photopolymerization initiator B shown below | 1.00 | part by mass |
| Chiral agent A shown below | 4.18 | parts by mass |
| Surfactant F1 shown below | 0.1 | parts by mass |

Mixture X of rod-like liquid crystal compounds

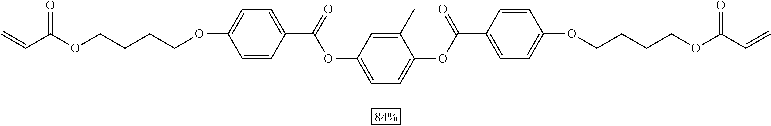 [SMILES: C=CC(=O)OCCCCOc1ccc(C(=O)Oc2ccc(OC(=O)c3ccc(OCCCCOC(=O)C=C)cc3)c(C)c2)cc1]

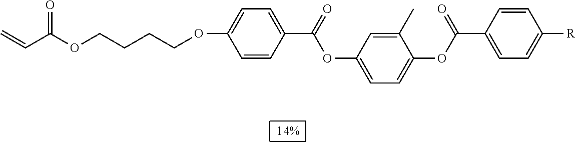

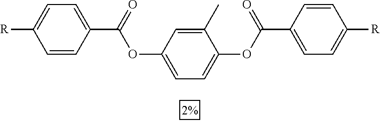

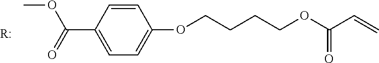

In the above-described mixture X, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol·cm.

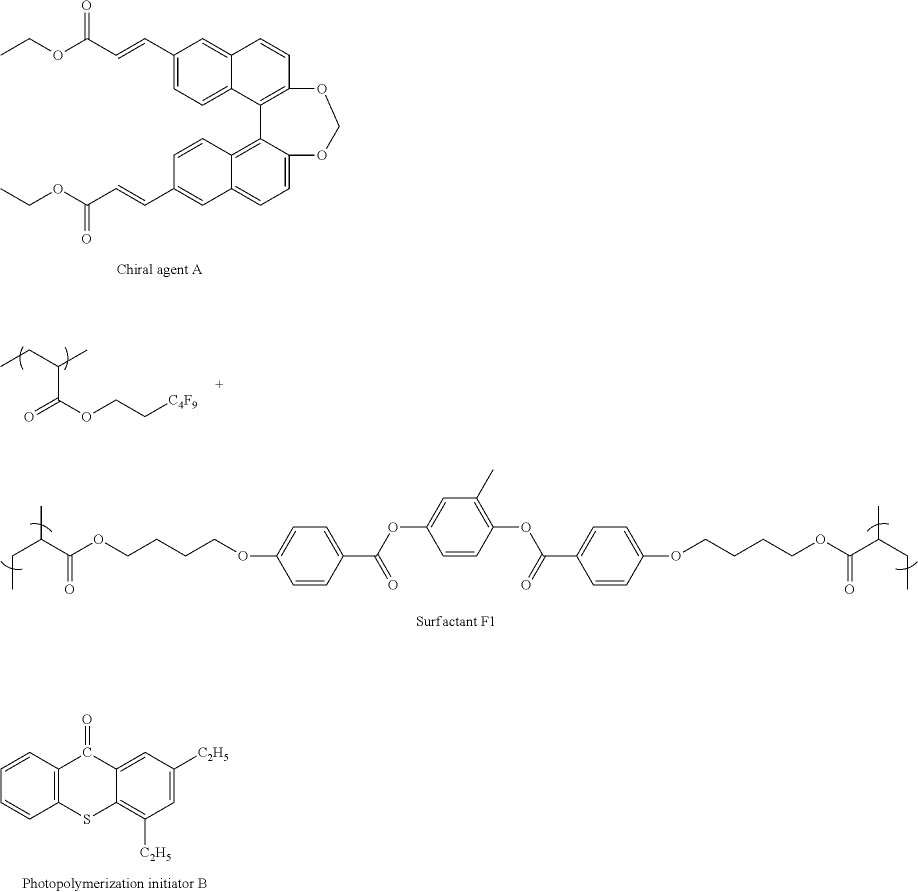

The chiral agent A was a chiral agent in which helical twisting power (HTP) was reduced by light.

### [Coating Liquid R-2 for Reflective Layer]

A coating liquid was prepared in the same manner as in the coating liquid R-1 for a reflective layer, except that the amount of the chiral agent A added was changed as shown in Table 1.

TABLE 1

| | Amount of |
|---|---|
| Name of | chiral agent |
| coating liquid | (part by mass) |
| Liquid R-1 | 4.18 |
| Liquid R-2 | 3.00 |

### [Coating Liquid D-1 for Reflective Layer]

A composition shown below was stirred and dissolved in a container held at 50° C. to prepare a coating liquid D-1 for a reflective layer. Here, D represents a coating liquid containing a disk-like liquid crystal compound.

Coating liquid D-1 for reflective layer

| | | |
|---|---|---|
| Disk-like liquid crystal compound (A) shown below | 80 | parts by mass |
| Disk-like liquid crystal compound (B) shown below | 20 | parts by mass |
| Polymerizable monomer E1 shown below | 10 | parts by mass |
| Surfactant F2 shown below | 0.3 | parts by mass |
| Photopolymerization initiator | 3 | parts by mass |
| (IRGACURE 907 manufactured by BASF SE) | | |
| Chiral agent A shown above | 5.45 | parts by mass |
| Methyl ethyl keonte | 290 | parts by mass |
| Cyclohexanone | 50 | parts by mass |

Disk-like liquid crystal compound (A) 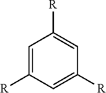 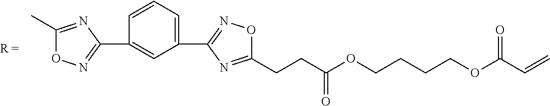 [SMILES: C=CC(=O)OCCCCOC(=O)CCc1nc(-c2cccc(-c3noc(C)n3)c2)no1]
Disk-like liquid crystal compound (B) 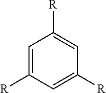 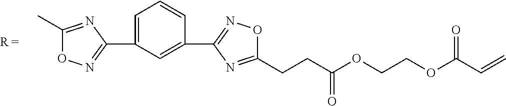 [SMILES: C=CC(=O)OCCOC(=O)CCc1nc(-c2cccc(-c3noc(C)n3)c2)no1]
Polymerizable monomer E1 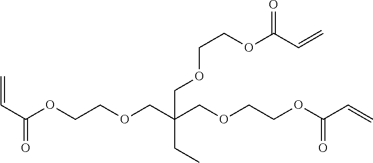 [SMILES: C=CC(=O)OCCOCC(CC)(COCCOC(=O)C=C)COCCOC(=O)C=C]
Surfactant F2

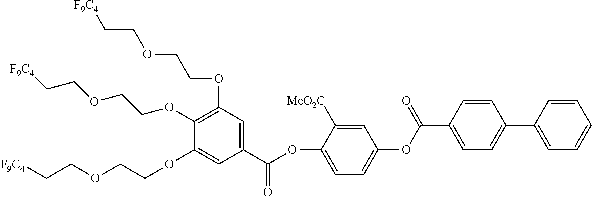

### [Coating Liquids D-2 and D-3 for Reflective Layer]

Coating liquids D-2 and D-3 for a reflective layer were prepared in the same manner as in the coating liquid D-1 for a reflective layer, except that the amount of the chiral agent A added was changed as shown in Table 2.

TABLE 2

| | Amount of |
|---|---|
| Name of | chiral agent |
| coating liquid | (part by mass) |
| Liquid D-1 | 5.45 |
| Liquid D-2 | 4.52 |
| Liquid D-3 | 4.10 |

### [Production of Reflective Circular Polarizer 1]

A PET film (manufactured by TOYOBO Co., Ltd., A4265) having a thickness of 100 μm was prepared as a temporary support, and a PET surface on a side where an easy adhesive layer was not formed was subjected to the rubbing treatment.

The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a first blue light reflective layer consisting of a cholesteric liquid crystal layer (first cholesteric liquid crystal layer). The irradiation with light was carried out from the side of the cholesteric liquid crystal layer. In this case, the coating thickness was adjusted such that the film thickness of the cured first blue light reflective layer was 2.6 μm.

Next, the surface of the first blue light reflective layer was subjected to a corona treatment at a discharge amount of 150 W·min/m², and the surface subjected to the corona treatment was coated with the coating liquid D-1 for a reflecting layer using a wire bar coater.

Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflective layer (second cholesteric liquid crystal layer) on the first blue light reflective layer. The irradiation with light was carried out from the side of the cholesteric liquid crystal layer. In this case, the coating thickness was adjusted such that the film thickness of the cured second blue light reflective layer was 2.0 μm.

Next, the second blue light reflective layer was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a green light reflective layer (third cholesteric liquid crystal layer) on the second blue light reflective layer. The irradiation with light was carried out from the side of the cholesteric liquid crystal layer. Here, the coating thickness was adjusted so that the film thickness of the cured green light reflective layer was 2.7 μm.

Next, the green light reflective layer was coated with the coating liquid R-2 for a reflective layer using a wire bar coater and dried at 110° C. for 72 seconds.

Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflective layer (fourth cholesteric liquid crystal layer) on the green light reflective layer. The irradiation with light was carried out from the side of the cholesteric liquid crystal layer. Here, the coating thickness was adjusted so that the film thickness of the cured red light reflective layer was 3.4 μm.

Next, the surface of the red light reflective layer was subjected to a corona treatment at a discharge amount of 150 W·min/m², and the surface subjected to the corona treatment was coated with the coating liquid D-3 for a reflecting layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a yellow light reflective layer (fifth cholesteric liquid crystal layer) on the red light reflective layer. The irradiation with light was carried out from the side of the cholesteric liquid crystal layer. Here, the coating thickness was adjusted so that the film thickness of the cured yellow light reflective layer was 3.4 μm.

By the above procedure, a reflective circular polarizer 1 including the first cholesteric liquid crystal layer to the fifth cholesteric liquid crystal layer in this order was obtained.

For each cholesteric liquid crystal layer of the produced reflective circular polarizer 1, a reflection center wavelength and a film thickness are shown in Table 3. Here, the reflection center wavelength shown in Table 3 corresponds to a central wavelength of the reflected light of the above-described cholesteric liquid crystal layer. The reflection center wavelength (central wavelength of the reflected light) was confirmed by producing a film of each cholesteric liquid crystal layer, obtained by applying only a single layer. The film thickness was obtained by SEM.

TABLE 3

| | Type of | Reflection center | Film |
|---|---|---|---|
| | coating | wavelength | thickness |
| | liquid | (nm) | (μm) |
| Fifth layer | Liquid D-3 | 586 | 3.4 |
| Fourth layer | Liquid R-2 | 661 | 3.4 |
| Third layer | Liquid D-2 | 531 | 2.7 |
| Second layer | Liquid D-1 | 441 | 2.0 |
| First layer | Liquid R-1 | 475 | 2.6 |

In addition, in a case where the temporary support (PET film) of the obtained reflective circular polarizer 1 was peeled off and the SHG measurement was performed on the surface of the first cholesteric liquid crystal layer (first layer), the degree of alignment of the liquid crystal compound was 0.65. In addition, in a case of being incorporated into a virtual image display apparatus, a variation in director orientation of the liquid crystal compound in the effective region was 3.2°.

In addition, in a case where the SHG measurement of the surface of the reflective circular polarizer 1 on the fifth cholesteric liquid crystal layer (fifth layer) side was carried out, a degree of alignment of the liquid crystal compound was 0.62. In addition, in a case of being incorporated into a virtual image display apparatus, a variation in director orientation of the liquid crystal compound in the effective region was 85°.

[Preparation of reflective circular polarizer 2]

### [Coating Liquid R-3 for Reflective Layer]

A composition shown below was stirred and dissolved in a container held at 70° C. to prepare a coating liquid R-3 for a reflective layer. Here, R represents a coating liquid containing a rod-like liquid crystal compound.

Coating liquid R-3 for reflective layer

| | | |
|---|---|---|
| Methyl ethyl ketone | 120.9 | parts by mass |
| Cyclohexanone | 21.3 | parts by mass |
| Rod-like liquid crystal compound X2 shown below | 100.0 | parts by mass |
| Photopolymerization initiator B shown above | 1.00 | part by mass |
| Chiral agent A shown above | 4.18 | parts by mass |
| Surfactant F1 shown above | 0.1 | parts by mass |

Rod-Like Liquid Crystal Compound X2

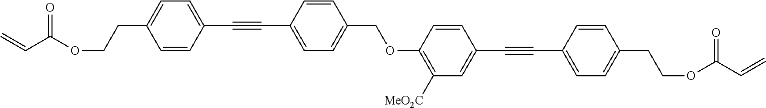 [SMILES: C=CC(=O)OCCc1ccc(C#Cc2ccc(COc3ccc(C#Cc4ccc(CCOC(=O)C=C)cc4)cc3C(=O)OC)cc2)cc1]

### [Coating Liquid R-4 for Reflective Layer]

A coating liquid was prepared in the same manner as in the coating liquid R-3 for a reflective layer, except that the amount of the chiral agent A added was changed as shown in Table 4.

TABLE 4

| | Amount of |
|---|---|
| Name of | chiral agent |
| coating liquid | (part by mass) |
| Liquid R-3 | 4.35 |
| Liquid R-4 | 2.86 |

### [Coating Liquid D-4 for Reflective Layer]

The following composition was stirred and dissolved to prepare a coating liquid D-4 for a reflective layer. Here, D represents a coating liquid containing a disk-like liquid crystal compound.

Coating liquid D-4 for reflective layer

| | | |
|---|---|---|
| Disk-like liquid crystal compound (C) shown | 100 | parts by mass |
| below | | |
| Polymerizable monomer shown above E1 | 10 | parts by mass |
| Surfactant F2 shown above | 0.3 | parts by mass |
| Photopolymerization initiator | 3 | parts by mass |
| (IRGACURE 907 manufactured by BASF SE) | | |
| Chiral agent A shown above | 5.45 | parts by mass |
| Methylene chloride | 340 | parts by mass |

Disk-Like Liquid Crystal Compound (C)

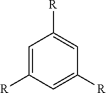

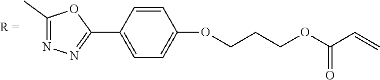 [SMILES: C=CC(=O)OCCCOc1ccc(-c2nnc(C)o2)cc1]

### [Coating Liquids D-5 and D-6 for Reflective Layer]

Coating liquids D-5 and D-6 for a reflective layer were prepared in the same manner as in the coating liquid D-4 for a reflective layer, except that the amount of the chiral agent A added was changed as shown in Table 5.

TABLE 5

| | Amount of |
|---|---|
| Name of | chiral agent |
| coating liquid | (part by mass) |
| D-4 | 5.83 |
| D-5 | 4.65 |
| D-6 | 4.04 |

A reflective circular polarizer 2 was produced by performing coating in the same manner as in the reflective circular polarizer 1, except that the coating liquids were used and the film thickness after curing was adjusted to the value shown in Table 6.

Accordingly, in the reflective circular polarizer 2, as in the reflective circular polarizer 1, the first layer (first cholesteric liquid crystal layer) was formed on the alignment film.

TABLE 6

| | Type of | Reflection center | Film |
|---|---|---|---|
| | coating | wavelength | thickness |
| | liquid | (nm) | (μm) |
| Fifth layer | Liquid D-6 | 606 | 2.4 |
| Fourth layer | Liquid R-4 | 706 | 1.9 |
| Third layer | Liquid D-5 | 526 | 2.3 |
| Second layer | Liquid D-4 | 420 | 1.4 |
| First layer | Liquid R-3 | 464 | 1.4 |

In a case where the temporary support (PET film) of the obtained reflective circular polarizer 2 was peeled off and the SHG measurement was performed on the surface of the first cholesteric liquid crystal layer (first layer), the degree of alignment of the liquid crystal compound was 0.67. In addition, in a case of being incorporated into a virtual image display apparatus, a variation in director orientation of the liquid crystal compound in the effective region was 2.6°.

In addition, in a case where the SHG measurement was performed on the surface of the reflective circular polarizer 2 on the fifth cholesteric liquid crystal layer (fifth layer) side, the degree of alignment of the liquid crystal compound was 0.64. In addition, in a case of being incorporated into a virtual image display apparatus, a variation in director orientation of the liquid crystal compound in the effective region was 79°.

### [Preparation of λ/4 Wavelength Plate]

A λ/4 wavelength plate 1 having reverse wavelength dispersibility was prepared with reference to the method described in paragraphs 0151 to 0163 of JP2020-084070A.

In the λ/4 wavelength plate 1, Re was 141 nm and Rth was 71 nm.

### [Preparation of Positive C-Plate 2]

A positive C-plate 2 was produced by adjusting the film thickness with reference to the method described in paragraphs 0132 to 0134 of JP2016-053709A. Here, the support was changed from a polyethylene terephthalate film (PET film) to a triacetyl cellulose film (TAC film).

In the positive C-plate 2, Re was 0.1 nm and Rth was-80 nm.

### <Production of Linear Polarizer>

A linear polarizer was produced through the following procedure.

### (Production of Cellulose Acylate Film 1)

### <Production of Core Layer Cellulose Acylate Dope>

The following composition was put into a mixing tank and stirred to dissolve each component, thereby preparing a cellulose acetate solution used as a core layer cellulose acylate dope.

Core layer cellulose acylate dope

| | | |
|---|---|---|
| Cellulose acetate having acetyl substitution | 100 | parts by mass |
| degree of 2.88 | | |
| Polyester compound B described in Examples | 12 | parts by mass |
| of JP2015-227955A | | |
| Compound F shown below | 2 | parts by mass |
| Methylene chloride (first solvent) | 430 | parts by mass |
| Methanol (second solvent) | 64 | parts by mass |

Compound F

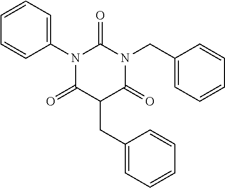 [SMILES: O=C1C(Cc2ccccc2)C(=O)N(c2ccccc2)C(=O)N1Cc1ccccc1]

### <Preparation of Outer Layer Cellulose Acylate Dope>

10 parts by mass of the following matting agent solution was added to 90 parts by mass of the core layer cellulose acylate dope to prepare a cellulose acetate solution to be used as an outer layer cellulose acylate dope.

Matting agent solution

| | |
|---|---|
| Silica particles with average particle size of 20 nm | 2 parts by mass |
| (AEROSIL R972, manufactured by Nippon | |
| Aerosil Co., Ltd.) | |
| Methylene chloride (first solvent) | 76 parts by mass |
| Methanol (second solvent) | 11 parts by mass |
| Core layer cellulose acylate dope described above | 1 part by mass |

### <Production of Cellulose Acylate Film 1>

The core layer cellulose acylate dope and the outer layer cellulose acylate dope were filtered through filter paper having an average hole diameter of 34 μm and a sintered metal filter having an average hole diameter of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction. Thereafter, the film was further dried by being transported between the rolls of the heat treatment device to prepare an optical film having a thickness of 40 μm, and the optical film was used as a cellulose acylate film 1. Re of the obtained cellulose acylate film 1 was 0 nm.

### (Formation of Photo-Alignment Layer PA1)

The cellulose acylate film 1 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment layer PA1. A film thickness thereof was 0.3 μm.

(Coating liquid S-PA-1 for forming alignment layer)

| | | |
|---|---|---|
| Polymer M-PA-1 shown below | 100.00 | parts by mass |
| Acid generator PAG-1 shown below | 5.00 | parts by mass |
| Acid generator CPI-110TF shown below | 0.005 | parts by mass |
| Xylene | 1220.00 | parts by mass |
| Methyl isobutyl ketone | 122.00 | parts by mass |

Polymer M-PA-1 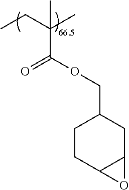 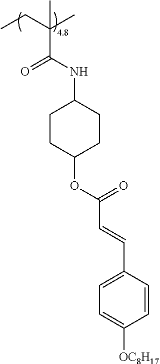 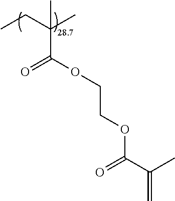
Acid Generator PAG-1 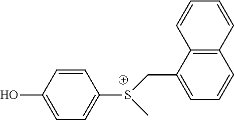 [SMILES: C[S+](Cc1cccc2ccccc12)c1ccc(O)cc1] 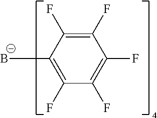
Acid generator CPI-110TF

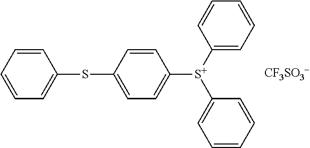

### (Formation of Light-Absorbing Anisotropic Layer P1)

The obtained photo-alignment layer PA1 was continuously coated with the following coating liquid S-P-1 for forming a light-absorbing anisotropic layer using a wire bar to form a coating layer.

Next, the formed coating layer was heated at 140° C. for 30 seconds, and the coating layer was cooled to room temperature (23° C.). Next, the coating layer P1 was heated at 90° C. for 60 seconds and cooled to room temperature again.

Thereafter, the coating layer P1 was irradiated with an LED lamp (central wavelength of 365 nm) for 2 seconds under an irradiation condition of illuminance of 200 mW/cm², thereby forming a light-absorbing anisotropic layer P1 on the photo alignment layer PA1. A film thickness thereof was 1.6 μm.

Composition of coating liquid S-P-1 for forming light-absorbing anisotropic layer

| | | |
|---|---|---|
| Dichroic substance D-1 shown below | 0.25 | parts by mass |
| Dichroic substance D-2 shown below | 0.36 | parts by mass |
| Dichroic substance D-3 shown below | 0.59 | parts by mass |
| Polymer liquid crystal compound M-P-1 shown below | 2.21 | parts by mass |
| Low-molecular-weight liquid crystal compound M-1 | 1.36 | parts by mass |
| Polymerization initiator | 0.200 | parts by mass |
| IRGACURE OXE-02 (manufactured by BASF SE) | | |
| Surfactant F-3 shown below | 0.026 | parts by mass |
| Cyclopentanone | 46.00 | parts by mass |
| Tetrahydrofuran | 46.00 | parts by mass |
| Benzyl alcohol | 3.00 | parts by mass |

Dichroic substance D-1 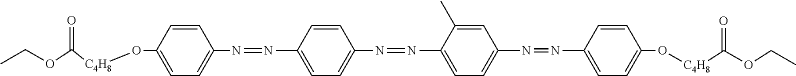
Dichroic substance D-2 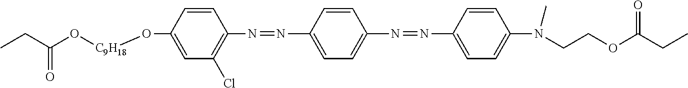
Dichroic substance D-3 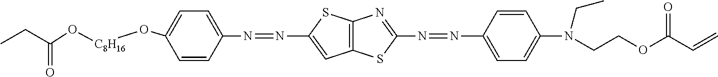
Polymer liquid crystal compound M-P-1 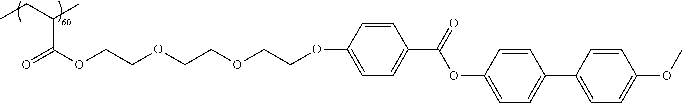 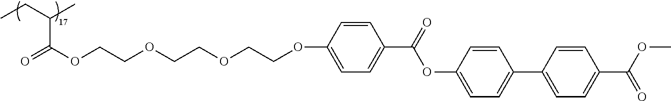 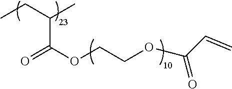
Low-Molecular-Weight Liquid Crystal Compound M-1 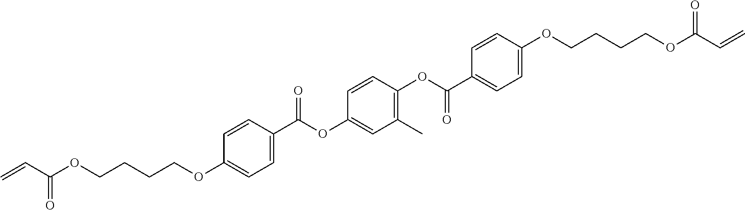 [SMILES: C=CC(=O)OCCCCOc1ccc(C(=O)Oc2ccc(OC(=O)c3ccc(OCCCCOC(=O)C=C)cc3)c(C)c2)cc1]
Surfactant F-3

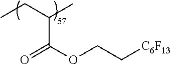

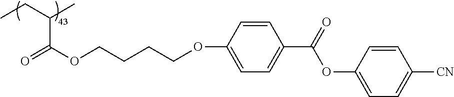

### [Production of Laminated Film]

The above-described members were bonded to each other according to the following procedure to obtain a laminated film 1 and a laminated film 2.

A UV adhesive Chemi-seal U2084B (manufactured by ChemiTech Inc., refractive index n after curing n: 1.60) was applied onto the PMMA substrate using a wire bar coater such that the thickness was set to 2 μm. The light-absorbing anisotropic layer P1 was bonded to the formed adhesive layer. The light-absorbing anisotropic layer P1 was bonded using a laminator such that the surface of the light-absorbing anisotropic layer P1 opposite to the temporary support (cellulose acylate film 1) was in contact with the adhesive layer.

Next, the inside of the purge box was purged with nitrogen until the oxygen concentration reached 100 ppm or less, and then the adhesive layer was cured by irradiating the light-absorbing anisotropic layer P1 from the temporary support side with ultraviolet rays of a high-pressure mercury lamp. The illuminance was 25 mW/cm² and the irradiation amount was 1,000 mJ/cm².

Finally, the temporary support of the light-absorbing anisotropic layer P1 was peeled off.

A UV adhesive layer was formed on the exposed surface of the light-absorbing anisotropic layer P1 according to the same procedure as described above, and the λ/4 wavelength plate 1 was bonded thereto. Here, the λ/4 wavelength plate 1 and the light-absorbing anisotropic layer P1 were laminated such that the angle formed by the slow axis of the λ/4 wavelength plate 1 and the absorption axis of the light-absorbing anisotropic layer P1 was 45°.

Next, a UV adhesive layer was formed on the λ/4 wavelength plate 1 according to the same transfer procedure as described above, and the positive C-plate 2 was bonded thereto.

Finally, a UV adhesive layer was formed on the positive C-plate 2 according to the same procedure as described above, and the reflective circular polarizer 1 was bonded thereto to produce a laminated film 1. The bonding was performed such that the surface of the reflective circular polarizer 1 on the fifth cholesteric liquid crystal layer side and the UV adhesive layer were in contact with each other. In addition, the PET film of the reflective circular polarizer 1 of the laminated film 1 was peeled off to expose the surface of the first cholesteric liquid crystal layer.

The laminated film 1 had the reflective circular polarizer 1, the positive C-plate 2, the λ/4 wavelength plate 1, and the light-absorbing anisotropic layer P1 in this order.

A laminated film 2 having the reflective circular polarizer 2 was produced according to the same procedure as in the production of the laminated film 1, except that the reflective circular polarizer 2 was included instead of the reflective circular polarizer 1.

### [Production of Folded-Back Optical System]

### [Formation of Half Mirror on Lens]

A convex surface side of a lens (convex meniscus lens LE1076-A (diameter: 2 inches, focal length: 100 mm) manufactured by Thorlabs, Inc.) was subjected to aluminum vapor deposition so that the reflectance was 40%, thereby forming a half mirror. A half-mirror-equipped lens 1 was obtained according to the above-described procedure.

### [Forming of Reflective Circular Polarizer and Production of Folded-Back Optical System 1]

The reflective circular polarizer 1 was bonded to the concave surface side of the half-mirror-equipped lens 1 while being formed, thereby producing a folded-back optical system 1.

The reflective circular polarizer 1 was formed on a curved surface and bonded according to the following procedure.

First, a pressure-sensitive adhesive sheet “NCF-D692 (5)” manufactured by LINTEC Corporation was bonded to the surface of the first cholesteric liquid crystal layer of the reflective circular polarizer 1. In a state where the separator film of the pressure-sensitive adhesive sheet was peeled off, the pressure-sensitive adhesive sheet was disposed to face the concave surface of the half-mirror-equipped lens 1, and the first cholesteric liquid crystal layer was disposed, and vacuum forming was performed by the method described in JP2012-116094A. The forming temperature was set to 110° C.

In this way, the reflective circular polarizer 1 was formed, and a folded-back optical system 1 in which the reflective circular polarizer 1 was bonded to the concave surface of the half-mirror-equipped lens 1 was produced.

### Production of Virtual Image Display Apparatus of Example 1

The lens portion of the virtual reality display apparatus “PICO4” manufactured by PICO was removed, and the folded-back optical system was taken out.

Since the image display device of PICO4 emitted levorotatory circularly polarized light, the polarizing plate on the surface of the image display device was peeled off, and a circular polarization plate that emitted dextrorotatory circularly polarized light was bonded instead.

Next, the produced folded-back optical system 1 was assembled instead of the taken-out folded-back optical system, and a virtual image display apparatus of Example 1 was produced. In this case, the folded-back optical system 1 was installed such that the convex surface side, that is, the half mirror side was on the image display device side.

Therefore, in the present example, in the reflective circular polarizer 1, the first cholesteric liquid crystal layer (first layer) serves as a surface on the image display device side.

### Production of Virtual Image Display Apparatus of Example 2

A folded-back optical system was produced in the same manner as in the folded-back optical system 1, except that the reflective circular polarizer 2 was included instead of the reflective circular polarizer 1.

A virtual image display apparatus of Example 2 was produced in the same manner as in Example 1, except that the folded-back optical system was included.

Therefore, in the present example, in the reflective circular polarizer 2, the first cholesteric liquid crystal layer (first layer) serves as a surface on the image display device side.

### Production of Virtual Image Display Apparatus of Example 3

A folded-back optical system was produced in the same manner as in the folded-back optical system 1, except that the laminated film 1 was included instead of the reflective circular polarizer 1.

A virtual image display apparatus of Example 3 was produced in the same manner as in Example 1, except that the folded-back optical system was included.

In a case where the laminated film 1 was formed into the half-mirror-equipped lens 1, the first cholesteric liquid crystal layer side of the reflective circular polarizer 1 in the laminated film 1 was set to be the concave surface side of the half-mirror-equipped lens 1, and the forming temperature was set to 110° C.

Therefore, in the present example, in the reflective circular polarizer 1 of the laminated film 1, the first cholesteric liquid crystal layer (first layer) serves as a surface on the image display device side.

### Production of Virtual Image Display Apparatus of Example 4

A folded-back optical system was produced in the same manner as in the folded-back optical system 1, except that the laminated film 2 was included instead of the reflective circular polarizer 1.

A virtual image display apparatus of Example 4 was produced in the same manner as in Example 1, except that the folded-back optical system was included.

In a case where the laminated film 2 was formed into the half-mirror-equipped lens 1, the first cholesteric liquid crystal layer side of the reflective circular polarizer 2 in the laminated film 2 was set to be the concave surface side of the half-mirror-equipped lens 1, and the forming temperature was set to 110° C.

Therefore, in the present example, in the reflective circular polarizer 2 of the laminated film 2, the first cholesteric liquid crystal layer (first layer) serves as a surface on the image display device side.

### Production of Virtual Image Display Apparatus of Comparative Example 1

A folded-back optical system was produced in the same manner as in the folded-back optical system 1, except that, in a case where the reflective circular polarizer 1 was formed into the half-mirror-equipped lens 1, the fifth cholesteric liquid crystal layer side of the reflective circular polarizer 1 was set to be the concave surface side of the half-mirror-equipped lens 1.

A virtual image display apparatus of Comparative Example 1 was produced in the same manner as in Example 1, except that the folded-back optical system was included.

Therefore, in the present example, in the reflective circular polarizer 1, the fifth cholesteric liquid crystal layer (fifth layer) serves as a surface on the image display device side.

### Evaluation

### [Evaluation of Ghost]

The virtual image display apparatuses of Examples and Comparative Examples were produced five times each by the same production procedure.

A black-and-white checker pattern was displayed on the image display panel of the produced virtual image display apparatus, and the visibility of the ghost was evaluated by visual observation according to the following standard.

In practice, the evaluation of A to C is preferable, and the evaluation of A or B is more preferable.
A; ghost is not visible at all.
B; ghost is slightly visible, but not noticeable.
C; weak ghost is visible.
D; slightly strong ghost is visible.
E; strong ghost is visible.

Table 7 shows the evaluation results for the ghost of Examples and Comparative Examples.

In each of the evaluations performed five times, the evaluation value in a case where the ghost was smallest and the evaluation value in a case where the ghost was largest are shown.

TABLE 7

| | | SHG measurement on | | | |
|---|---|---|---|---|---|
| | | liquid crystal compound | | | |
| | | on surface on image | | Visibility of ghost | |
| | Film included | display device side | | Individual | Individual |
| | in folded- | | Variation in | with | with |
| | back optical | Degree of | director | minimized | maximized |
| | system | alignment | orientation | ghost | ghost |
| Example 1 | Reflective | 0.65 | 3.2° | C | C |
| | circular | | | | |
| | polarizer 1 | | | | |
| Example 2 | Reflective | 0.67 | 2.6° | C | C |
| | circular | | | | |
| | polarizer 2 | | | | |
| Example 3 | Laminated film 1 | 0.65 | 3.2° | A | A |
| Example 4 | Laminated film 2 | 0.67 | 2.6° | A | A |
| Comparative | Reflective | 0.62 | 85° | B | E |
| Example 1 | circular | | | | |
| | polarizer 1 | | | | |

From the results shown in Table 7, in the virtual image display apparatuses of Examples 1 to 4, the visibility of the ghost was stably small, and the variation was small. On the other hand, in the virtual image display apparatus of Comparative Example 1, the visibility of the ghost varied depending on the individual, and in the worst individual, the ghost was strongly visible.

### EXPLANATION OF REFERENCES

10, 11, 12: ray
200: reflective circular polarizer
300: half mirror
400: circular polarization plate
401: λ/4 wavelength plate
402: absorptive linear polarizer
500: image display device
600: folded-back optical system
1000: virtual image display apparatus

What is claimed is:

1. A virtual image display apparatus comprising at least: an image display device; and a folded-back optical system including a reflective circular polarizer, wherein the reflective circular polarizer includes a cholesteric liquid crystal layer, and in the cholesteric liquid crystal layer, a degree of alignment of a liquid crystal compound is 0.5 or more on a surface on an image display device side, and a variation in a director orientation of the liquid crystal compound in an effective region is 30° or less.

2. The virtual image display apparatus according to claim 1, wherein the reflective circular polarizer includes a plurality of cholesteric liquid crystal layers.

3. The virtual image display apparatus according to claim 2, wherein the reflective circular polarizer includes at least a cholesteric liquid crystal layer formed of a first liquid crystal compound substantially consisting of a rod-like liquid crystal compound and a cholesteric liquid crystal layer formed of a second liquid crystal compound substantially consisting of a disk-like liquid crystal compound.

4. The virtual image display apparatus according to claim 1, wherein at least a λ/4 wavelength plate and an absorptive linear polarizer are laminated in this order on a surface of the reflective circular polarizer on a viewing side.

5. The virtual image display apparatus according to claim 1, wherein the reflective circular polarizer is formed in a curved-surface shape.

6. The virtual image display apparatus according to claim 2, wherein at least a λ/4 wavelength plate and an absorptive linear polarizer are laminated in this order on a surface of the reflective circular polarizer on a viewing side.

7. The virtual image display apparatus according to claim 2, wherein the reflective circular polarizer is formed in a curved-surface shape.

8. The virtual image display apparatus according to claim 3, wherein at least a λ/4 wavelength plate and an absorptive linear polarizer are laminated in this order on a surface of the reflective circular polarizer on a viewing side.

9. The virtual image display apparatus according to claim 3, wherein the reflective circular polarizer is formed in a curved-surface shape.

10. The virtual image display apparatus according to claim 4, wherein the reflective circular polarizer is formed in a curved-surface shape.
